(19) United States
(12) Patent Application Publication
(10) Pub. No.: US 2004/0129794 A1
(43) Pub. Date: Jul. 8, 2004

(54) Miniature fountain

(76) Inventors: Ronald S. Deichmann, House Springs, MO (US); Robert L. Kuykendal, High Ridge, MO (US)

Correspondence Address: Henry W. Cummings, 3313 W. Adams St., St. Charles, MO, 63301, US

(21) Appl. No.: 10/674,678

(22) Filed: Sep. 29, 2003

Related U.S. Application Data
(62) Division of application No. 09/813,143, filed on Mar. 21, 2001, now Pat. No. 6,641,056.

(51) Int. Cl. B05B 17/08

(52) U.S. Cl. 239/17

(57) ABSTRACT

The self-contained miniature laminar ornamental fountain shown in FIG. 1 comprises an enclosure and water reservoir, 5, a pump, 1 a flow control means, 3, pipe or tubing means, 2 to conduct water from the pump 1, to a laminar nozzle, 4. Water in the reservoir, 5, enters the pump, 1, where it is pressurized, thence through the adjustable valve or flow control means, 3 through the tubing, 2. to the laminar nozzle, 4. The laminar stream, 6, emanating ftom the laminar nozzle, 4, forms a graceful arch and then falls back into the reservoir, 5, to repeat the cycle. In another embodiment of the invention the fountain includes one or more additional laminar or non-laminar nozzles. In another embodiment the fountain above in which the laminar nozzle(s) contain internal lighting means for producing lighted laminar streams. In another embodiment in the fountain, the laminar stream(s) are interrupted to form jets of water which appear to leap ftom place to place.

### I FIELD OF THE INVENTION

This invention discloses a complete, self-contained miniature laminar ornamental fountain, which for example may be displayed on a table top.

### II BACKGROUND OF THE INVENTION

U.S. Pat. No. 5,160,086 granted Nov. 3, 1992 is directed to a lighted laminar flow nozzle for use in decorative water fountains and industrial applications. It includes fluid flow through a double-walled bladder-like fluid supply hose 32 into a fluid chamber 10 and through a diffuser material 20, past trapped air pockets 18 and exiting through a knife edged orifice 12. The fluid nozzle is mounted upon one or more stages of vibration dampening springs 30, and the outlet orifice 12 is located off center from the walls 11 of the fluid chamber so that pump surges and vibrations are greatly dampened and the output fluid stream 14 is sufficiently laminar that light is conducted through the length of the output fluid stream 14 similar to a fiber optic cable.

U.S. Pat. No. 5,641,120 granted Jun. 24, 1997 is an improvement on the first described U.S. Pat. No. 5,160,086. This U.S. Pat. No. 5,641,120 includes an improved method and apparatus for obtaining a laminar stream of fluid flow including providing a generally cylindrical outer wall 13a, a generally cylindrical inner wall 14 defining a generally cylindrical outer chamber 13; introducing fluid into the outer chamber 13 tangentially at 12, directing fluid flow within the outer chamber circumferentially through chamber 13; providing an inner chamber 36 defined by the generally cylindrical inner wall located within or below the outer chamber 13. An opening 33 is formed in the lower portion of the inner cylindrical wall 14, which causes fluid to flow downwardly through the opening 33 from the outer chamber 13 into the inner chamber 36. Located within the inner chamber is a diffuser material having a plurality of parallel fluid flow paths. Fluid is caused to flow through the diffuser material to dampen major currents of fluid velocity. The diffuser material has an arcuate upper surface 84. Fluid is caused to flow radially inwardly from the arcuate surface through an orifice 20 located above the diffuser material to form a laminar fluid stream.

In U.S. Pat. No. 5,785,089 granted Jul. 28, 1998 an apparatus is disclosed wherein a pressure inlet to a chamber includes a double walled bladder-like hose wherein fluid is made to flow into parallel manner, first forwardly within the tube and then backwardly in the tube, and then again forward in the tube to isolate the system from pressure variations including pump noise.

### III SUMMARY OF THE INVENTION

The self-contained miniature laminar ornamental fountain shown in FIGS. 1 and 2 comprises an enclosure and water reservoir, 5, a pump, 1, an adjustable valve or other flow control means, 3, conduit means such as pipe or 2 to conduct water from the pump, 1, to a laminar nozzle, 4. Water in the reservoir, 5, enters the pump, 1, where it is pressurized, thence through the adjustable valve or flow control means, 3, through the conduit means 2, to the laminar nozzle, 4. The laminar stream, 6, emanating from the laminar nozzle, 4, forms a graceful arch and then falls back into the reservoir, 5, to repeat the cycle. In another embodiment of the invention the fountain includes one or more additional laminar or non-laminar nozzles nozzles. In another embodiment shown in FIGS. 3 and 4 in the fountain, includes pulsation reducing means 7 and shutter means 9 for interrupting the laminar stream(s) 4 to form jets of water which appear to leap from place to place. In another embodiment the laminar nozzle(s) 4 contains internal lighting means 8 for producing lighted laminar streams.

### IV THE DRAWINGS

FIG. 1 is a plan view of one embodiment of the minature laminar ornamental fountain of the present invention.

FIG. 2 is side elevation view of the the minature laminar ornamental fountain of the present invention shownin FIG. 1.

FIG. 3 is a plan view of another embodiment of the minature laminar ornamental fountain of the present invention.

FIG. 4 is side elevation view of the minature laminar ornamental fountain of the present invention shown in FIG. 3.

FIG. 5 is a schematic sectional view illustrating that substantially all the water flowing from the diffuser to the exit orifice travels substantially the same distance.

FIG. 6 is a perspective view of another embodiment of the improved diffuser of the present invention.

FIG. 7 is a perspective view of the improved nozzle assembly of the present invention.

FIG. 8 is a plan view of the improved nozzle assembly of the present invention looking in the direction of the arrows along the line 8-8 in FIG. 7.

FIG. 9 is a side elavation view of one embodiment of the pulse reducing structure of the present invention.

FIG. 10 is an orthagonal elavation view of the embodiment shown in FIG. 9.

FIG. 11 is a side elavation view of another pulse reducing embodiment of the present invention.

FIG. 12 is a side elavation view of another pulse reducing embodiment of the present invention

FIG. 13 is a side elavation view of another pulse reducing embodiment of the present invention.

FIG. 14 is a side elavation view of another pulse reducing embodiment of the present invention.

FIG. 15 is a perspective view of a prior art flow stream shutter used in a different environmoment in the closed position.

FIG. 15a is a perspective view of a prior art flow stream shutter used in a different environmoment in the open position.

FIG. 15b is a perspective view of a prior art flow stream shutter used in a different environmoment in the closed position.

FIG. 16 is a front view of the fountain shutter of the present invention in the closed position.

FIG. 17 is side elevation view of the fountain shutter of the present invention.

FIG. 18 is a front view of the fountain shutter of the present invention in the open position.

FIG. 19 is a front view of a second embodiment the of the present invention, with the shutter in the closed position.

FIG. 20 is a side elevation view of the second embodiment the of the present invention, with the shutter in the open position

FIG. 21 is a view looking in the direction of the arrows along the line 21-21-in FIG. 19.

FIG. 22 is a schematic view of an embodiment including a lighting system in the nozzle.

FIG. 23 is a schematic, perspective view of another embodiment of the invention directed to a decorative fountain.

### V DESCRIPTION OF PREFERRED EMBODIMENTS

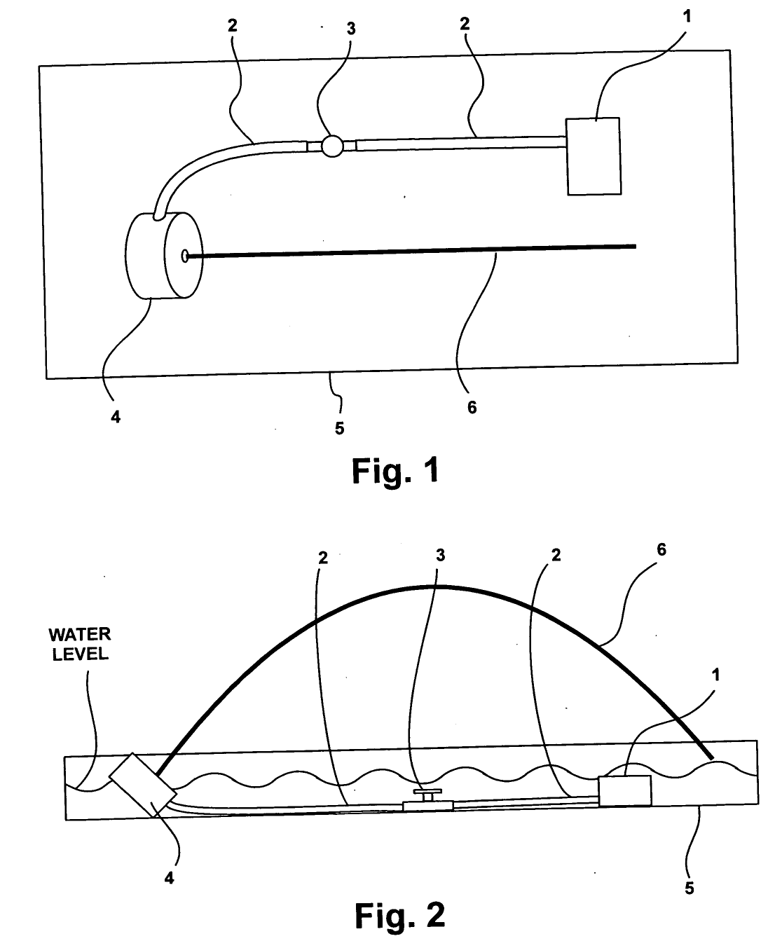

The self-contained miniature laminar ornamental fountain Mown in FIGS. 1 and 2 comprises an enclosure and water reservoir. 5, a pump, 1, an adjustable valve or other flow contro means, 3, conduit means such pipe 2 to conduct water from the pump. I. to a laminar nozzle. 4. Water in the reservoir, 5, enters the pump, 1, where it is pressurized, thence through the adjustable valve or flow control means, 3, through the conduit means 2, to the laminar nozzle. 4. The laminar stream, 6, emanating from the laminar nozzle, 4, forms a graceful arch and then falls back into the reservoir, 5, to repeat the cycle.

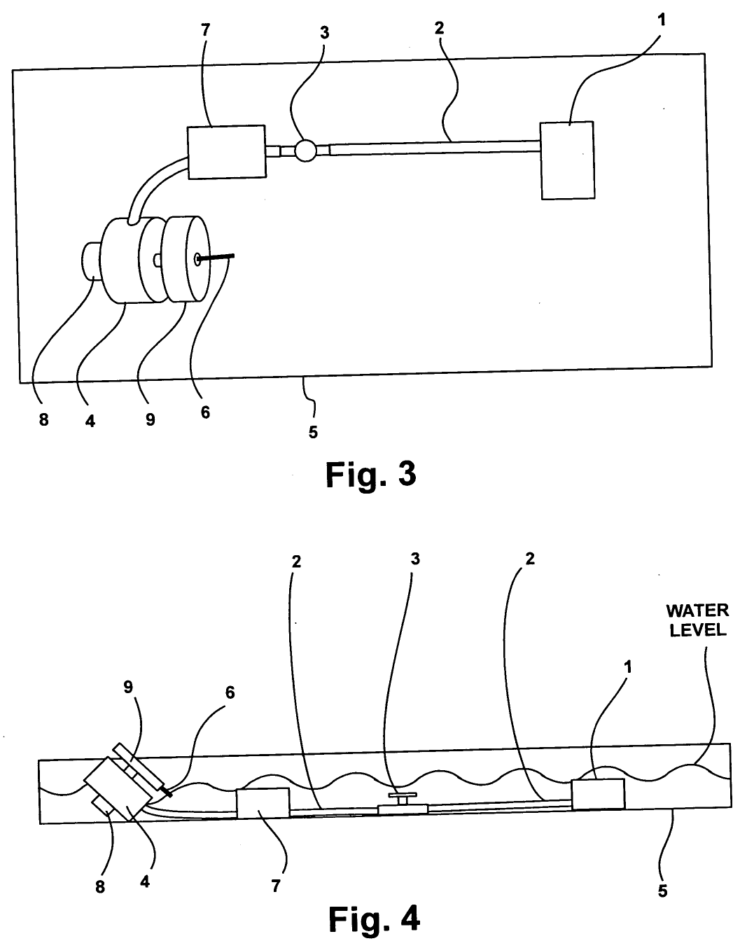

In another embodiment of the invention the fountain includes one or more additional laminar or non-laminar nozzles. In another embodiment shown in FIGS. 3 and 4 the fountain includes pulsation reducing means 7 and shutter means 9 for interrupting the laminar stream(s) 6 to form jets of water which appear to leap from place to place. In another embodiment the laminar nozzle(s) 4 contain internal lighting means 8 for producing lighted laminar streams.

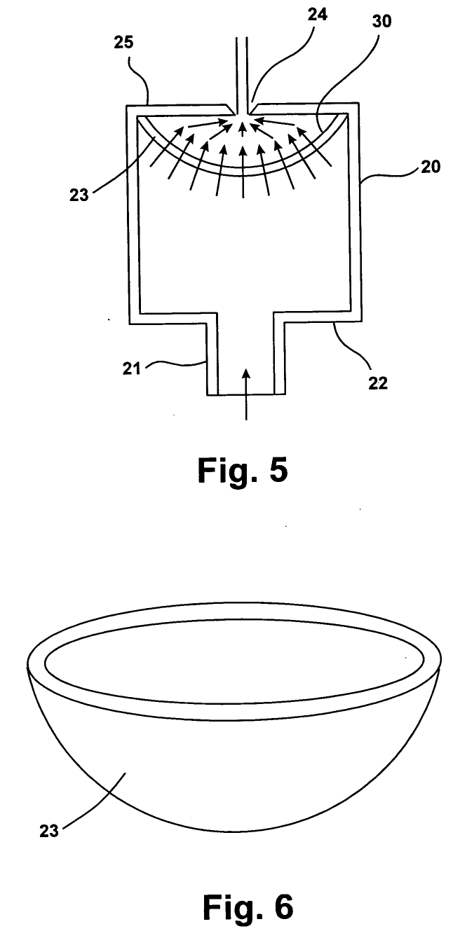

Preferably the laminar nozzle, as disclosed and claimed in Doc. No. WW-12 hereby incorporated into the present application by this reference, as shown in FIGS. 5 and 6 comprises a cylindrical nozzle body enclosure, 20, with an entry port 21 at one end, 22, a location opposite the knife-edged exit orifice 24, centered at the opposite end 25. Contained within said nozzle body. 20. is a hollow hemisph<<ical means far diffusing 23, positioned such that the knife-edged exit orifice is at the center of the concave side 30 of the hollow bemispherlcal means for diffusing 23, and such that all fluid trav<<sing from the inlet port, 21. to the exit orifice, 24, must travel through the means for diffusing. 23. The hemispherical means far diffilsing 23, can be made, for example, of 1/2 inch to 1 inch thick potyester fiber air filter material which has been heat formed over a hemispherical mandrel.

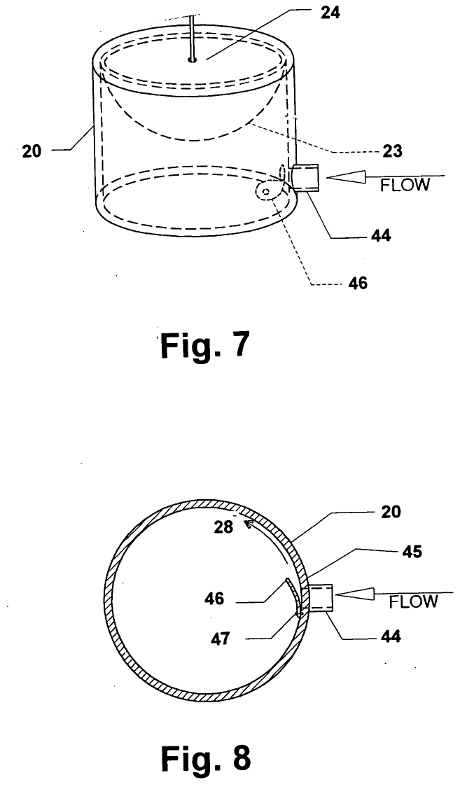

Alternatively, as also diaclosed in Doc. No WW-12 hereby inco)rporated into the present application by this reference, shown in FIGS. 7 and 8, comprises the nozzle body, 20, diffuscr, 23 and exit orifice, 24. However. in this embodiment the inlet port. is moved from the center 21 of the end wall 22 to a location 44 to allow fluid to enter the nozz!e body, 20, radjally though the side wall 11 against baffie 46 mounted on body 20 at 47 to flow tangentially 28 and then longitudinally through diffuser 23 and exit orifice 24.

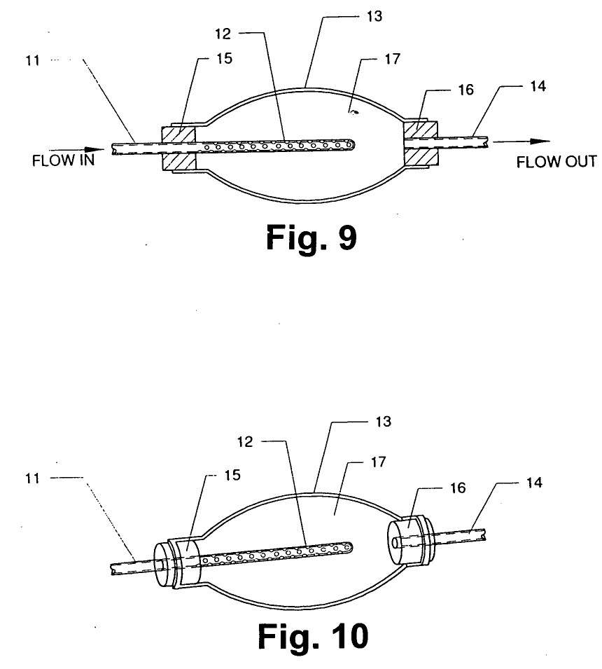

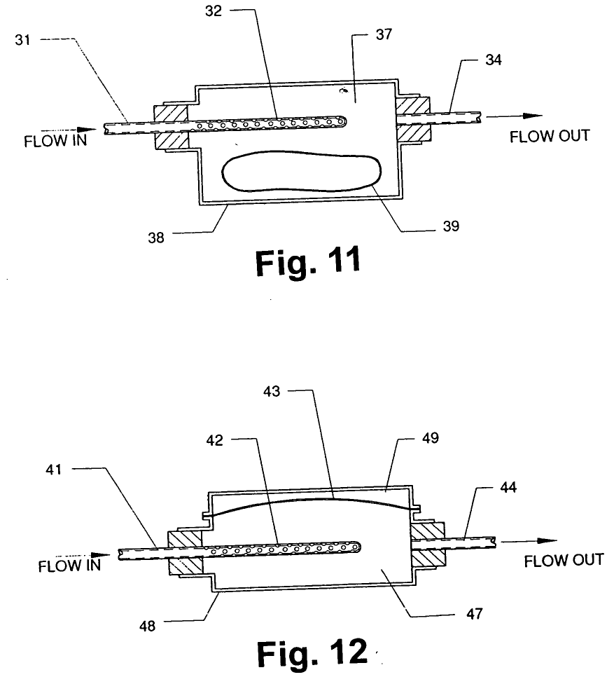

In another embodiment of the invention the fountain includes one or more additlon.laminar or non-laminar nonles nozzles, which are operated in substantially the same manner as the single laminar nozzle shown and described above or in U.S. Pat. Nos. 5,160,086 and 5,641,120, hereby incorporated into the present application by this reference. In another embodiment shown in FIGS. 9 and 10 in the fountain. includes pulsatjon reducing means 7 disclosed and claimed in docket No WW-16 hereby incorporated into the present application by this reference. FIG. 9 shows an enclosed vesael, 1, with an outlet pipe, 14, endcaps. 15 and 16, and side walls, 13, made of an elastic, bladder-like material. The inlet rigid pipe. 11, is perforated with a large number of lateral holes, 12, all of which are substantially smaller than the internal diameter of pipe. 11. In this example the pipe internal diameter is 1/2″ and the lateral holes are each 1/8″ diameter and there are 24 of them spaced at random along the length of the pipe, 11. Pressurized fluid is made to flow in the inlet pipe, 11, will tend to flow out through the various lateral holes, 12, at differing increments of their periodic pressure cycles and into the enclosed vessel. 17. Remaining slight pressure variations will also tend to be absorbed and smoothed by expansion and contraction of the bladder-like sidewall, 13. Fluid then flowing out from the enclosed vesllel, 17, through outlet pipe, 14, will be substantially free of slight pressure variations or “pump noise”. FIG. 10 shows an orthogonal view of the described device. Another embodiment shown in FIG. 11 comprises a rigid inlet pipe 31 which is perforated with a number of lateral holes. 32, an outlet pipe, 34, and an enclosed vessel, 38. Within the enclosed vessel, 38, is a balloon-like, gas filled chamber, 39, which functions like the bladder-like sidewalls, 13, of FIG. 9 to expand and contract to absorb minute pressure pulsations.

Another embodiment of the invention shown in FIG. 12 comprises a substantially rigid inlet pipe, 41, which is perforated with a large number of lateral holes, 42, an outlet pipe, 44, and an enclosed, substantially rigid chambered vessel, 48. In this embodiment said chambered vessel, 48, comprises a fluid chamber, 47, and a gas chamber, 49, separated by an elastic, bladder-like membrane, 43. In this embodiment, pulsations remaining after the fluid has entered through the inlet port, 41, and flown through the lateral holes, 42, will tend to be absorbed by expansion and contraction of the bladder-like membrane, 43, and the consequent compression and expansion of the enclosed gas chamber, 49.

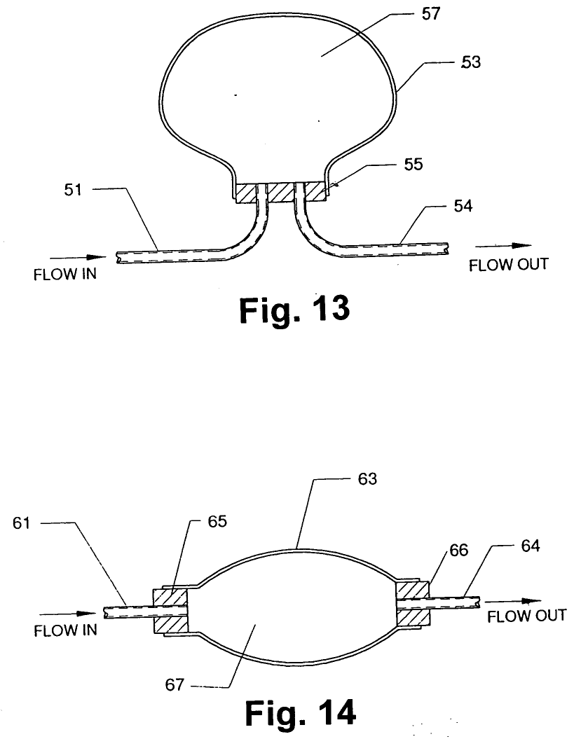

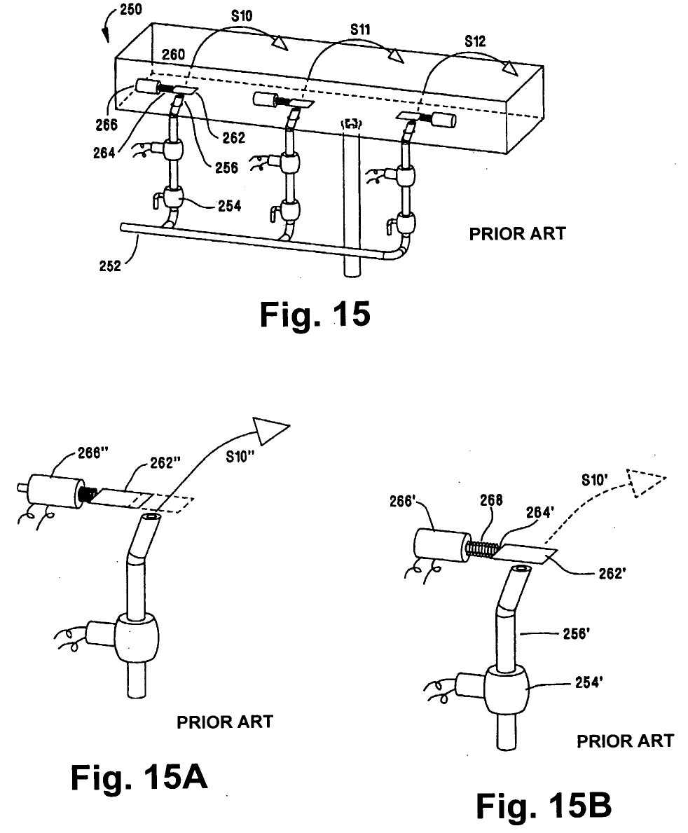

Another embodiment of the invention, shown in FIG. 13, comprises a substantially rigid inlet pipe, 51, an enclosed chamber, 57, surrounded by an elastic, bladder-like enclosure, 53, with an outlet pipe, 54, and an end cap, 55. In this embodiment pulsations tend to be absorbed by expansion and contraction of the bladder-like enclosure.

Another embodiment of the invention, shown in FIG. 14, comprises a substantially rigid inlet pipe, 61, projecting through an end cap, 65, into a chamber, 67, with an outlet pipe, 64, projecting through a second end cap, 66. Said chamber is enclosed by a bladder-like membrane, 63. Pressurized fluid that is made to pass through inlet pipe, 61, contains pulsations which tend to be absorbed by the expansion and contraction of the bladder-like membrane, 63. The fluid then flows out through outlet pipe, 64, with the pulsations substantially reduced.

This invention also includes a Fountain Shutter described in Doc. Nos WW-15 hereby incorporated into the present application by this reference as if fully set forth herein.

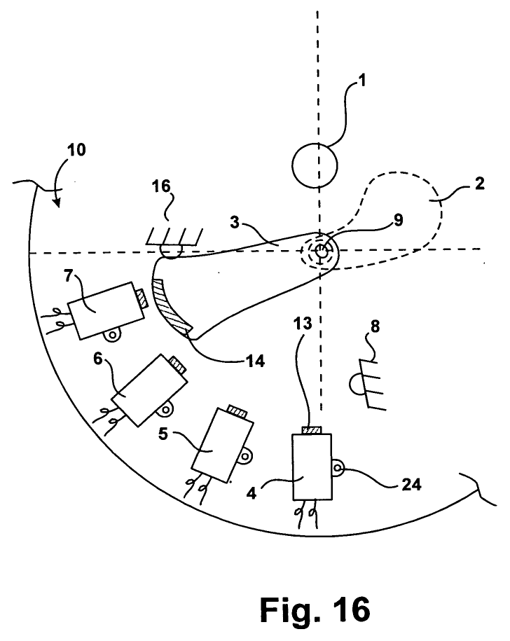

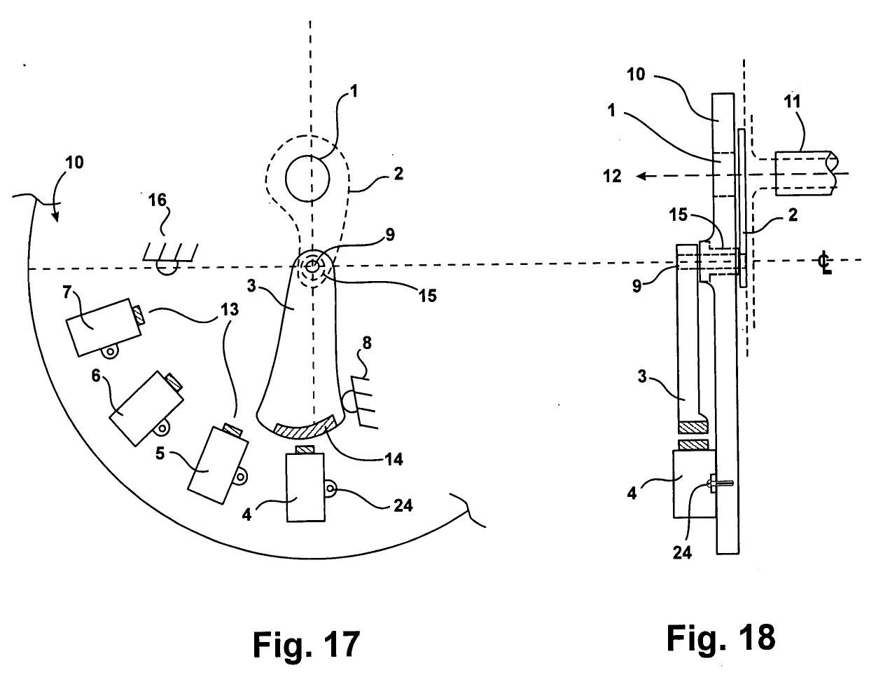

As shown in FIGS. 16-18, the fountain nozzle is placed behind a cover, 10, with an exit aperture, 1, and a shutter, 2, which prevents or allows the stream, 12, to exit, according to its rotational position around shaft, 9, and bearing, 15. The opening and closing of said shutter, 2, is controlled by armature, 3, with its tip, 14, composed of iron or other magnetic material. The armature, 3, is affixed to the rotational shaft, 9. The armature magnetic tip, 14, is positioned in close proximity to electromagnets 4, 5, 6 and 7 with their magnetic cores, 13, mounted on cover 10, with fasteners 24 such that the armature, 3, stays positioned against bumper, 8, whenever electromagnet, 4, remains activated and consequently shutter, 2, continues to block the exit port 1 and no water is discharged.

By de-activating electromagnet, 4, and then sequentially activating electromagnet 5, then, 6, and then 7, the armature, 3, is made to rotate upon shaft, 9, and the shutter, 2, which is affixed to shaft, 9, will move so that it is no longer blocking exit orifice, 1, and the stream will traverse through exit aperture, 1, in the direction, 12. So long as pressurized water is made to flow from nozzle, 11, and electromagnet, 7, remains energized, then the armature, 3, will remain positioned against bumper, 16, FIG. 18, and water will continue flowing in direction, 12.

In order to stop the flow 12, electromagnet, 7, is deenergized and electromagnets 6, 5 and 4 are energized in sequence to move the armature, 3, in the direction of bumper, 8, to close shutter 2.

FIGS. 16-18 disclose four electromagnets but this embodiment may be made to work just as well with two or three or any number of electromagnets.

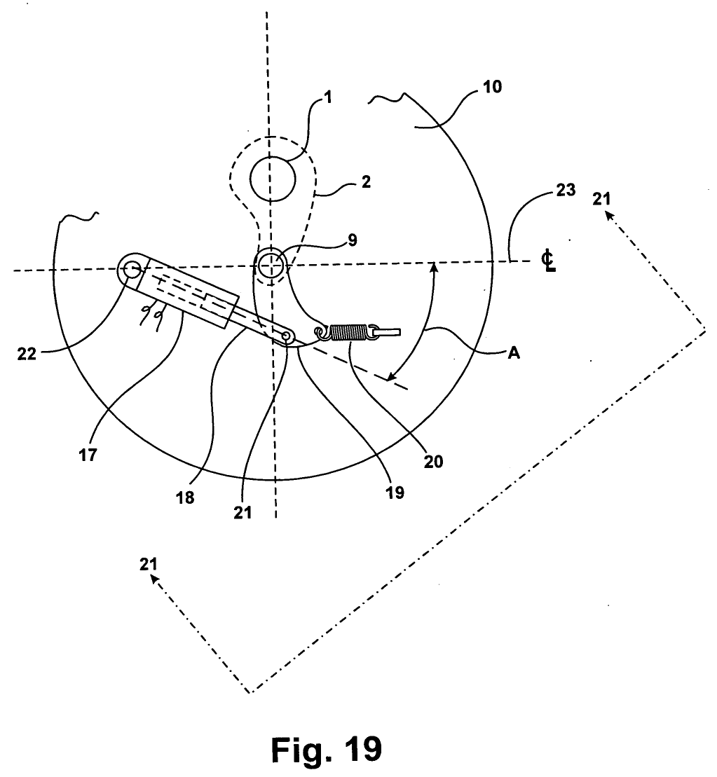

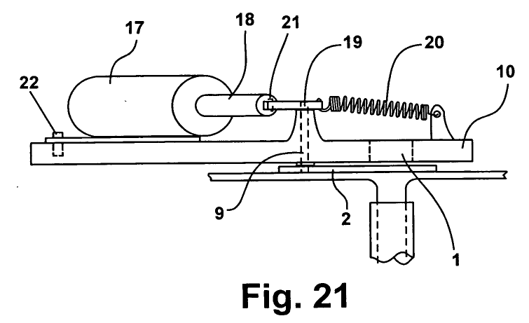

In an alternate embodiment shown in FIGS. 19-21, the exit aperture, 1, the shutter, 2, and the rotating shaft, 9, are the same as in the previous embodiment.

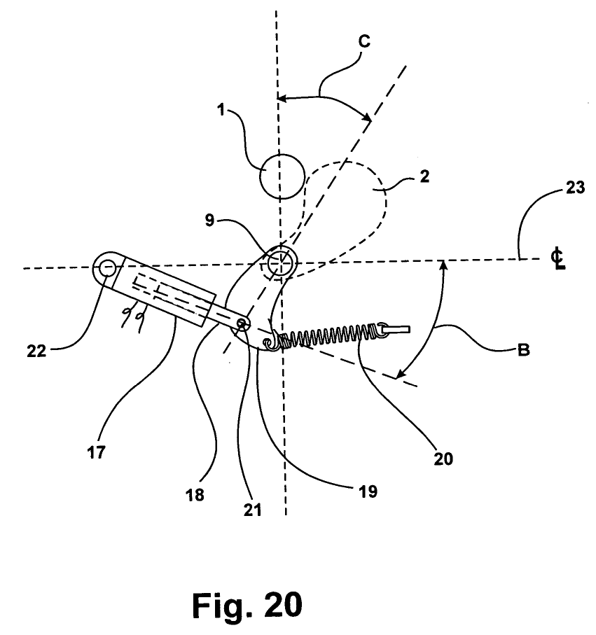

However, the means of rotating the shaft and opening the shutter utilize a plunger type electrical solenoid, 17, which retracts a plunger, 18, which is attached by a pin, 21, to a lever, 19, to overcome the force of a tension spring, 20, whenever the solenoid is electrically actuated as shown in FIG. 20. The solenoid, 17, is mounted to the cover, 10, by means of a pivot, 22, which permits the solenoid and plunger to maintain proper alignment with pin 21, by rotation of a few degrees around pin 21 to compensate for the rotation of lever 19.

FIG. 19 shows solenoid 17 in deactivated position which consequently has allowed tension spring 20 to retract and withdraw plunger 18 from solenoid 17. This action has rotated lever 19 around shaft 9 to which it is affixed, and has rotated shutter 2, also affixed to shaft 9, into the closed position. Angle A shows the rotational position of the solenoid relative to the centerline 23, around pin 22.

As an example, the angle A may be about 10 to 40 degrees, the angle B may be about 5 to 30 degrees, and the angle C may be about 30 to 60 degrees.

Also, the action of the spring and the plunger could be reversed as would be obvious to one skilled in the art.

In another embodiment the fountain described herinabove the laminar nozzle(s) contain internal lighting means for producing lighted laminar streams, as disclosed in U.S. Pat. Nos. 5,160,086 and 5,641, 120, or in Docket No. WW-17 hereby incorporated into the present application by this reference.

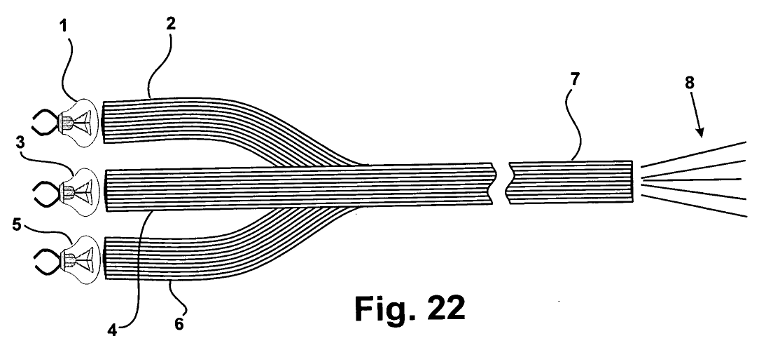

In FIG. 22, individual light source color A, 1, illuminates the end of fiber optic bundle, 2, and the light from color A, 2, travels the length of bundle, 2, where it joins and becomes part of the combined fiber optic bundle, 7, and shines out the far end of combined fiber optic bundle, 7, as the resulting light, 8. Likewise when light source color B, 3, is illuminated, the light travels the length of fiber optic bundle, 4, where it becomes part of the combined fiber optic bundle, 7, and shines out the end of combined fiber optic bundle, 7, as part of the resulting light, 8. Likewise when color C light source, 5, is illuminated, the light travels the length of fiber optic bundle, 6, where it becomes part of the combined fiber optic bundle, 7, and shines out the end of combined fiber optic bundle, 7, as part of the resulting light, 8. Individual fibers comprising bundles, 2, 4 and 6 are substantially intertwined and mixed into the combined fiber optic bundle, 7, so that the resulting light, 8, is comprised of multiple individual points of light and the resulting color tends to be a mix of the originating source colors, color A, 1, color B, 3 and color C, 5.

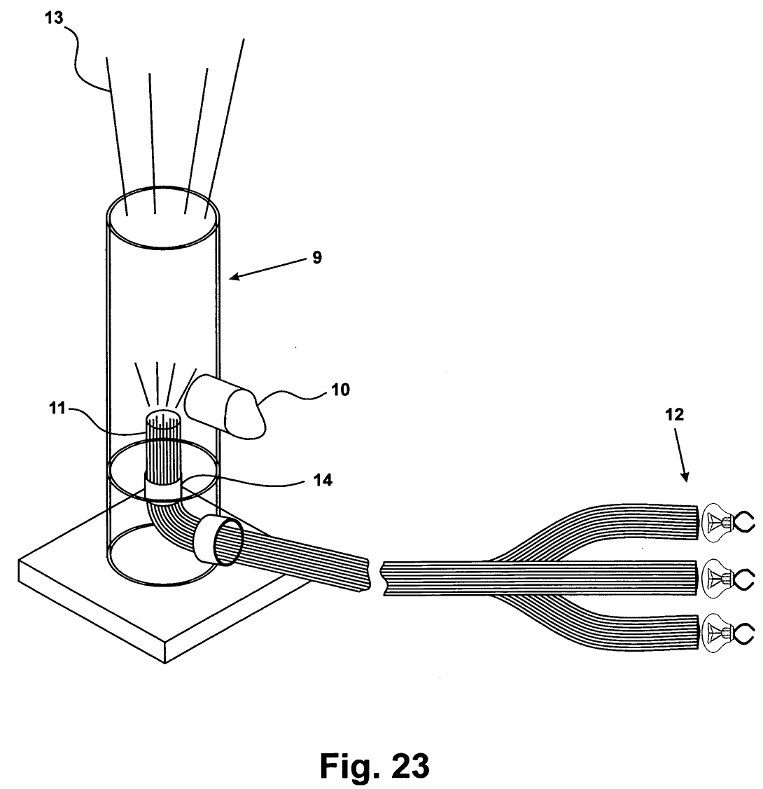

FIG. 23 illustrates three source color lights and three individual fiber optic bundles, collectively indicated at 12 and combined fiber optic bundle, 11, routed through a water light seal, 14, into the base of an ornamental fountain nozzle. In a manner familiar to any practitioner of the art of ornamental fountains, pressurized water is made to flow into inlet port, 10, of fountain nozzle, 9, creating an output stream, 13. With this invention, however, the output stream, 13, may be illuminated to any color or intensity within the limits of the three color light sources indicated at, 12.

In operation, then any individual source light may be turned on or off as desired. For example, if source color A, 1, is blue and source color B, 3, is green, then if only source color A, 1, is turned on the resulting light, 8, will be blue. Likewise if only source color B, 3, is turned on the resulting light, 8, will be green. However, if both source color A, 1, and source color B, 3, are turned on then the resulting light, 8, will be yellow. Any number of source color lights, 2 or more, may be combined in this manner and the individual source color lights may be of any color, type, or intensity such as incandescent, laser or LED, red, green or whatever. Also, this method and apparatus may be used for other applications in addition to fountain light.

In another embodiment in the fountain, the laminar stream(s) are interrupted to form jets of water which appear to leap from place to place, as disclosed for example in U.S. Pat. No. 5,678,617.and shown in FIGS. 4-6 therein, hereby incorporated into the present application by this reference.

What is claimed is:

1. A miniature laminar ornamental fountain comprising:
a fountain enclosure including a water reservoir;
pump means for pumping liquid to a laminar flow nozzle;
conduit means to conduct liquid from said pump to said laminar flow nozzle;
flow control means for controlling flow between said reservoir and said laminar flow nozzle; whereby water in the reservoir enters the pump means where it is pressurized, thence through said conduit means and said flow control means said laminar nozzle, and whereby the laminar stream emanating from said laminar nozzle forms a graceful arch and then falls back into the reservoir.

2 A miniature laminar ornamental fountain according to claim 1 including:
a diffuser located within said enclosure;
said diffuser comprising a porous filter formed into a hollow hemisphere having a convex surface and a concave surface having a center; an exit orifice located generally at said center of said concave surface, whereby as said fluid flows through said hollow hemispherical diffuser it has its Reynold's Number significantly reduced, and any turbulences on said on said convex side of said diffuser tend to be converted to a very great number of micro-turbulences which tend to be self canceling.

3. An improved nozzle assembly according to claim 2 wherein said diffuser is shaped as a hollow hemisphere and is centered upon said exit orifice substantially all water flowing from the diffuser to the exit orifice has substantially the same distance to travel from substantially all directions, and the fluid exiting said orifice is highly laminar.

4. An improved nozzle assembly according to claim 1 wherein said diffuser is made of polyester fiber air filter material.

5. An improved nozzle assembly according to claim 4 wherein material has been heat formed over a hemispherical mandrel.

6. An improved nozzle assembly according to claim 4 wherein said material is about 1/2 inch to 1 inch thick.

7. A miniature laminar ornamental fountain comprising:
a fountain enclosure including a water reservoir;
pump means for pumping liquid to a laminar flow nozzle;
conduit means to conduct liquid from said pump to said laminar flow nozzle;
flow control means for controlling flow between said reservoir and said laminar flow nozzle; whereby water in the reservoir enters the pump means where it is pressurized, thence through said conduit means and said flow control means said laminar nozzle, and whereby the laminar stream emanating from said laminar nozzle forms a graceful arch and then falls back into the reservoir: said enclosure including a generally cylindrical nozzle body having an exit orifice and continuous wall;
an inlet port for causing fluid to enter the nozzle assembly; radially though said wall toward the end opposite from said exit orifice;
a diffuser located within said assembly;
said diffuser comprising a porous filter formed into a hollow hemisphere having a convex surface and a concave surface having a center; an exit orifice located generally at said center of said concave surface;
a blade located on the inside of said wall directly in front of said inlet port, whereby water entering through said inlet port is forced to flow in a direction in a mild circular flow, whereby said circular flow will tend to distribute water flow and turbulence evenly whereby as said fluid flows through said hollow hemispherical diffuser it has its Reynold's Number significantly reduced, and any turbulences on said convex side of said diffuser tend to be converted to a large number of micro-turbulences which tend to be self canceling., and whereby the laminar stream emanating from said laminar nozzle forms a graceful arch and then falls back into the reservoir

8. A niinature ornamental fountain improved nozzle assembly according to claim 7 wherein said diffuser is shaped as a hollow hemisphere and is centered upon said exit orifice substantially all water flowing from the diffuser to the exit orifice has substantially the same distance to travel from substantially all directions, and the fluid exiting said orifice is highly laminar.

9. A minature ornamental fountain improved nozzle assembly according to claim 8 wherein said diffilser is made of polyester fiber air filter material.

10. A minature ornamental fountain improved nozzle assembly according to claim 8 wherein material has been heat formed over a hemispherical mandrel.

11. A minature ornamental fountain improved nozzle assembly according to claim 9 wherein said material is about '/2 inch to 1 inch thick.

12. Aminature ornamental fountain improved nozzle assembly according to claim 1 wherein the assembly includes at least one additional nozzle.

13. A minature ornamental fountain improved nozzle assembly according to claim 12 wherein the additional nozzle comprises a laminar nozzle.

14. A minature ornamental founta.in improved nozzle assembly according to claim 12 wherein the additional nozzle comprises laminar or non-laminar nozzles

15. A minature ornamental fountain improved nozzle assembly according to claim 1 wherein the assembly includes a fluid pressure pulsation absorbing device co˜rising an enclosed vessel with at least one elastic. bladder-like wall, with at least one inlet port and at least one outlet port.

16. A minature ornamental fountain improved nozzle assembly according to claim 1 wherein the assembly includes a fluid pressure pulsation absorbing device comprising an enclosed vessel with with at least one inlet port and at least one outlet port, said vessel containing therein a balloon-like, gas filled chamber.

17. A minature ornamental fountain improved nozzle assembly according to claim 1 wherein the assembly includes a fluid pressure pulsation absorbing device comprising an enclosed vessel with at least one inlet port and at least one outlet port said inlet port(s) comprising a rigid tube perforated with one or more lateral holes spaced at other than P distance apart, where P is defined as the physical length from peak to peak of one cycle of pressure pulsations generated by an impeller pump, along said rigid pipe.

18. A minature ornamental fountain improved nozzle assembly according to claim 1 wherein the assembly includes a fountain nozzle having means to discbarge a pressurized stream of water;
a shutter located adjacent said nozzle which prevents or allows said stream to exit;
said shutter integrally connected to a rotatable shaft;
an armature having a tip composed of magnetic material at one end and at the other end, affixed to the said rotatable shaft, whereby the opening and closing of said shutter is controlled by said armature;
at least two, first and second electromagnets having magnetic cores mounted adjacent said armatue tip;
said armature tip positioned in close proximity to said electromagnets such that in one position said armature stays positioned whenever said first electromagnet remains activated, and said shutter continues to block said exit port and no water is discharged;
and whereby by de-activating said first electromagnet and activating said second electromagnet, said armature is made to rotate said shaft and said shutter will rotate so that it is no longer blocking said exit orifice, and said stream will traverse through said exit aperture, and wherby in order to stop the flow said first electromagnet is deenergized and said second electromagnet is energized to move the armature in the direction to return said armature and said shutter to said first position.

19. A minatureornamental fountain control shutter assembly according to cl.aim 18 wherein more than one of said second electromagnets are provided.

20. A minature ornamental fountain control shutter assembly according to claim 18 wherein said shaft extends through a cover.

21. A minature ornamental fountain control shutter according to claim 19 wherein said second electromagnets are mounted on said cover.

22. A minature ornamental fountain improved nozzle assembly according to claim 1 wherein the assembly includes a fountain nozzle having means to discharge a pressurized stream of water;
a shutter located adjacent said nozzle which prevents or allows said stream to exit;
said shutter integrally connected to a rotatable shaft;
means for rotating said shaft and opening said shutter comprising an electrical solenoid mounted on a fixed support having a plunger mechanically connected a lever by a pin said lever in turn mechanically connected to said shutter;
said lever adopted to overcome the force of a tension spring mounted on a fi:xed support adjacent to said lever; whereby upon de-activating said solenoid, the force of said tension spring pulls said lever to withdraw said plunger, rotates said shaft, and closes said shutter to block fluid flow; and whereby when said solenoid is in anactua.ted condition in which said plunger is withdrawn, stretched said spring and rotated said lever, rotated said pin and rotated said shutter to uncover said aperature.

23. A minature ornamental fountain control shutter assembly according to claim 22 wherein said solenoid is mounted upon a fixed cover by means of a pivot, which pennits said solenoid and said plunger to maintain proper alignment with said pin.

24. A minature ornamental fountain having an improved nozzle assembly according to claim 1 wherein the assembly includes a fountain nozzle having means to discharge a pressurized stream of water;
a shutter located adjacent said nozzle which prevents or allows said stream to exit;
said shutter integrally connected to a rotatable shaft;
means for rotating said shaft and opening said shutter comprising an electrical solenoid -mounted on a fixed support having a plunger mechanically connected a lever by a pin said lever in turn mechanically connected to said shutter;
said lever adopted to overcome the force of a resilient means mounted on a fixed support adjacent to said lever; whereby upon de,activating said solenoid. the force of said resilient means pulls said lever, and closes said shutter to block fluid flow; and whereby when said solenoid is in an actuated condition said resilient means rotates said .lever, and moves said shutter to uncover said aperature.

25. A minature ornamental fountain having a shutter assembly according to claim 24 wherein said resilient means comprises a mechanical spring.

26. A minature ornamental fountain for creating a variable colored lighting effect at some desired remote location according to claim 1 comprising:
multiple source lighting means for lighting at least two colors selected from red. blue, green, yellow and white;
bundles of fiber optic cables having a first end and a second end;
means for lluminating said first end said bundles of fiber optic cables;
means for combining said bundles at said second end into at least one larger cable bundle;
and means for routing said larger cable to a desired remote location.

27. A minature ornamental fountain according to claim 26 including lighting means for lighting all the colors selected from red, blue, green, yellow and white.

28. A minature ornamental fountain according to claim 27 wherein individual fibers from said bundles are substantially intertwined and mixed into the combined fiber optic bundle whereby the resulting light is comprised of multiple individual points of light, and the resulting color comprises a mix of said originating source colors.

29. A minature ornamental fountain according to claim 1 comprising:
a fountin base having a substgantially wateriight seal;
multiple source lighting means for lighting at least two colors selected from red, blue, green, yellow and white.
bundles of fiber optic cables having a first end and a second end;
means for illuminating said first end said bundles of fiber optic cables;
means tor combining said bundles at said second end into at least one larger cable bundle;
means for routing said larger cable into said base and through said seal;
said fountain having an inlet port and a fountain nozzle;
means for supplying pressurized water into said inlet port, and into said fountain nozzle;
means for creating an output stream; and
means for illuminating output stream with said cable in said fiountain.

30. A minature ornamental fountain according to claim 29 comprising:
multiple source lighting means for lighting at least two colors selected from red, blue, green, yellow and white;
bundles of fiber optic cables having a first end and a second end;
means for illuminating said first end said bundles offiber optic cables;
means for combining said bundles at said second end into at least one larger cable bundle;
and means for routing said larger cable to a desired remote location.

31. A minature ornamental fountain according to claim 30 including lighting means for lighting all colors of red, blue, green, yellow, and white claim 32. A minature ornamental fountain according to claim 31 wherein individual fibers ftom said bundles are substantially intertwined and mixed into the combined fiber optic bunde whereby the resulting light is comprised of mutiple individuaj points of light, and the resulting color comprises a mix of said originating source colors.

33. A minature ornamental fountain comprising:
a fountin base having a substgantially water light seal;
multiple source lighting means for lighting at least two colors selected from red, blue, green, yellow and white;
bundles of fiber optic cables having a first end and a second end;
means for lluminating said first end said bundles of fiber optic cables;
means for combining said bundles at said second end into at least one larger cable bundle;
means for routing said larger cable into said base and through said seal;
said fountain having an inlet port and a fountain nozzle;
means for supplying pressurized water into said inlet port, and into said fountain nozzle;
means for creating an output stream and means for illuminating output stream with said cable in said fountain.

34. A minature ornamental fountain accoring to CIaiin 33 including means for varying illuminated color.

35. Aminature ornamental fountain accoring to claim 34 including means for varying illuminated color intensity within the limits of said color light sources.

36. A minature ornamental fountain accoring to claim 30 including means for varying iluminated color intensity within the limits of said color light sources.
